(19) United States
(12) Patent Application Publication
(10) Pub. No.: US 2007/0242032 A1
(43) Pub. Date: Oct. 18, 2007

(54) Display Apparatus

(75) Inventors: Hubertus Maria Rene Cortenraad, Eindhoven (NL); Bokke Johannes Feenstra, Eindhoven (NL); Lucas Josef Maria Schlangen, Eindhoven (NL); Murray F. Gilles, Eindhoven (NL); Patrick John Baesjou, Eindhoven (NL); Anthonie Hendrik Bergman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,316

(22) PCT Filed: Sep. 14, 2005
(86) PCT No.: PCT/IB05/53015

§ 371 Date: Mar. 15, 2007

(30) Foreign Application Priority Data
Sep. 21, 2004 (EP) 04104553.5

(51) Int. Cl. G09G 3/20

(52) U.S. Cl. 345/107

(57) ABSTRACT

Display apparatus with a display area (2) having a plurality of pixels (9), a mixing unit (3) for preparing a predetermined quantity of color material for one of the plurality of pixels (9), and a transfer unit (4) for transferring the predetermined quantity for a pixel (9) to the associated pixel position in the display area (2). The transfer of color material can be based on an electro-wetting mechanism, an electrophoresis mechanism or a pumping mechanism.

### FIELD OF THE INVENTION

The present invention relates to a display for showing color images. More in particular, the present invention relates to a display apparatus comprising a display area having a plurality of pixels.

### PRIOR ART

Such a display is widely used today, e.g. in the form of cathode ray tube (CRT) displays or liquid crystal displays (LCD). In these known displays, colors of an image are constructed on the display by the use of three primary colored sub-pixels, usually red, green and blue. These sub-pixels have fixed positions on the display screen: In LCD's, the red, green and blue color filters are at fixed positions, and in CRT displays or plasma displays, the red, green and blue phosphors are at fixed positions. As a result, when a part of an image only comprises a red color, only one third of the actual display area is used, which is not very effective in view of color saturation and brightness of the display.

American U.S. Pat. No. 6,379,001 discloses a billboard system, in which an image is printed on a piece of a substrate, after which the substrate is moved in a viewable position. The image can be removed from the substrate, and a new image can be printed thereon, resulting in a flexible billboard display having the capability to show different images without the need to replace the substrate. This system however, requires a mechanical transport of the substrate, and repeated removal of the image from the substrate, which will cause wear of the substrate.

International patent application WO00/26890 discloses a system for changing the visual effect of a substrate, e.g. attached to clothing or shoes. The display unit used comprises a plurality of pixels formed into a matrix, in which the pixels comprise a silicon gel or a thermosetting polymer. Each pixel can display only a single color.

### SUMMARY OF THE INVENTION

The present invention seeks to provide a display apparatus for displaying (color) images, having an improved color saturation and brightness over existing displays.

According to the present invention, a display apparatus according to the preamble defined above is provided, which further comprises a mixing unit for preparing a predetermined quantity of pixel fill material for one of the plurality of pixels, and a transfer unit for transferring the predetermined quantity for a pixel to the associated pixel position in the display area. The predetermined quantity of pixel fill material (or color filter unit) may be composed of different basic color materials, such as an ink or dye having a specific color. E.g. the three primary colors red, blue and green may be used as basic color materials, in order to be able to produce any desired color of a pixel. As each pixel possibly has the same color, it is possible to provide a display apparatus having a much larger color saturation than present day CRT displays or LCD's.

In an embodiment of the present invention, the display apparatus further comprises a control unit connected to the mixing unit and the transfer unit for composing a predetermined image in the display area. This allows to use the display apparatus for displaying any image, by composing the image under control of the control unit, such as by column wise composing a picture. Furthermore, the display apparatus may further comprise a memory unit connected to the control unit for storing one or more images. This embodiment would allow to change a displayed image from one image to another. In an even further embodiment, the control unit is arranged to change the predetermined image for display on the display area depending on external inputs. An external input may e.g. be depending on a measurable parameter such as light level or temperature, or weather, season, holiday event, birthday, etc, and can be input as data to the control unit using appropriate sensing elements.

In a further embodiment, the display area of the display apparatus comprises a plurality of rows with pixels. This allows to transport the color filter unit to one end of a row first and then transfer the color filter unit to the proper pixel in that row. This row wise feeding of the display area considerably reduces the complexity of the transfer unit and display area. In an advantageous embodiment, a mixing unit and transfer unit is provided for each of the plurality of rows. This allows parallel preparation and transfer of color filter units to different rows, which will increase the speed of image change and completion.

The transfer unit and the display area are arranged in a further embodiment for electro-wetting based transport of the pixel fill material. In electro-wetting mechanisms, a droplet of oil like material can be transported between a sandwich structure of plates from one pixel position to another by controlling a local electric field. E.g., in a further embodiment, the display area comprises a top electrode and a plurality of pixel electrodes opposite the top electrode, in order to control the local electric field per pixel.

In a further embodiment, the transfer unit and the display area are arranged for transport of the pixel fill material based on electrophoresis. This is an alternative for the electro-wetting based embodiment, and uses charged particles suspended in a clear fluid. The display area may comprise a plurality of pixel electrodes for providing an electrical field from one pixel to a neighboring pixel. The charged particles of a color filter unit may then be transported from one pixel to another by controlling the electrical field.

In a further embodiment, the display area comprises barriers between neighboring pixels. This allows to keep a color filter unit on the correct pixel position after the transfer mechanism is powered down, e.g. when a complete image has been composed on the display area. These barriers may comprise a grid of coating material which repels the color material, e.g. the oil in an electro-wetting embodiment of the present display apparatus.

Alternatively, the barriers comprise electrical barriers. These electrical barriers or electrodes can utilize the same electro-wetting or electrophoresis principles, but at a much lower power setting compared to the transfer settings.

In further embodiments of the present display apparatus, use is made of immiscible fluids for filling the pixels of the display apparatus. More in particular, the display area may comprise at least one channel (in the case of a plurality of channels in a column or row wise orientation), and the color fill material for neighboring pixels comprises different immiscible fluids. The immiscible fluids may be a base material or medium or a solvent to which dyes or pigments can be added to obtain colored fluids.

In an alternative embodiment, the display area comprises at least one channel and the first predetermined quantities of color fill material for neighboring pixels are separated by a second predetermined amount of a fluid which is immiscible with the predetermined quantity of color fill material. The second predetermined amount may have no color (transparent) or have a fixed color (e.g. white or black). This may e.g. be accomplished using air as second immiscible fluid. Although some display area may then be lost due to the separating fluid, it allows an easy separation of color filter units in the pixels of the display area. A further advantage is that only a single mixing stage is needed for providing the color flow units. The full, bright color characteristic of the present display apparatus may be largely retained when the second predetermined amount is smaller than the first predetermined amount.

The size of pixels in the display area may in a further embodiment be varied by varying the predetermined amount of color fill material. This also allows to use sub pixels when using different immiscible fluids for each primary color, and thus allows to provide a correctly composed image on the display apparatus.

The different immiscible fluids may be chosen from the group comprising an aqueous fluid, a gaseous fluid (e.g. air), an apolar organic fluid, an fluorinated organic fluid. Embodiments are conceivable using two, three or even four different immiscible fluids, e.g. using three base colors plus a separation fluid. This latter embodiment has the added benefit that the fluids are easily separated after use in the present display apparatus for possible re-use.

In an even further embodiment, the display apparatus further comprises an outlet connected to the plurality of pixels (or rows of pixels) for receiving the predetermined quantity of pixel fill material when refreshing a pixel. Thus, an image can be removed from the display apparatus (or better, refreshed by a next image), and the pixel fill material of the previous image can be discarded or re-used.

The mixing unit, in a further embodiment, receives the pixel fill material from one or more pixel fill material containers, e.g. in the form of replaceable cartridges comprising color ink. A plurality of cartridges may be used for the colors used, which may comprise primary colors, but may also comprise other colors (even including metallic colors such as gold or silver).

In order to provide a possibility to easily re-use the pixel fill material used in the present display apparatus, a plurality of display areas are provided (e.g. on top of each other) in a further embodiment, and each of the plurality of display areas can receive pixel fill material of a single type (e.g. the primary colors).

The present display apparatus may be advantageously used in an electronic painting which is capable of displaying multiple images, or in an advertising display. The image can then be replaced for another image in a very easy and cost-effective manner.

### SHORT DESCRIPTION OF DRAWINGS

The present invention will be discussed in more detail below, using a number of exemplary embodiments, with reference to the attached drawings, in which

FIG. 1 shows a schematic view of a display apparatus according to an embodiment of the present invention;

FIG. 2 shows a simplified time frame view of the transport of a color filter unit in a single row of the display apparatus embodiment of FIG. 1;

FIG. 3 shows a simplified top view of a part of the display apparatus of FIG. 1 with separation means;

FIG. 4 shows a cross sectional view of a further embodiment of the present display apparatus;

FIG. 5 shows a partial view of a display area of a further embodiment of the present invention including pixel barriers;

FIG. 6 shows a schematic view of a further embodiment of the display apparatus according to the present invention using two immiscible fluids;

FIG. 7 shows a schematic view of a display area of a further embodiment of the present display apparatus using one of the immiscible fluids as a means for pixel separation;

FIG. 8 shows a schematic view of an even further embodiment of the present display apparatus using three immiscible fluids;

FIG. 9 shows a schematic view of a further embodiment of the present display apparatus using four immiscible fluids; and

FIG. 10 shows a schematic view of a further embodiment of the present display apparatus having a multi-nozzle configuration.

### DETAILED DESCRIPTION OF EXEMPLARY EMBODIMENTS

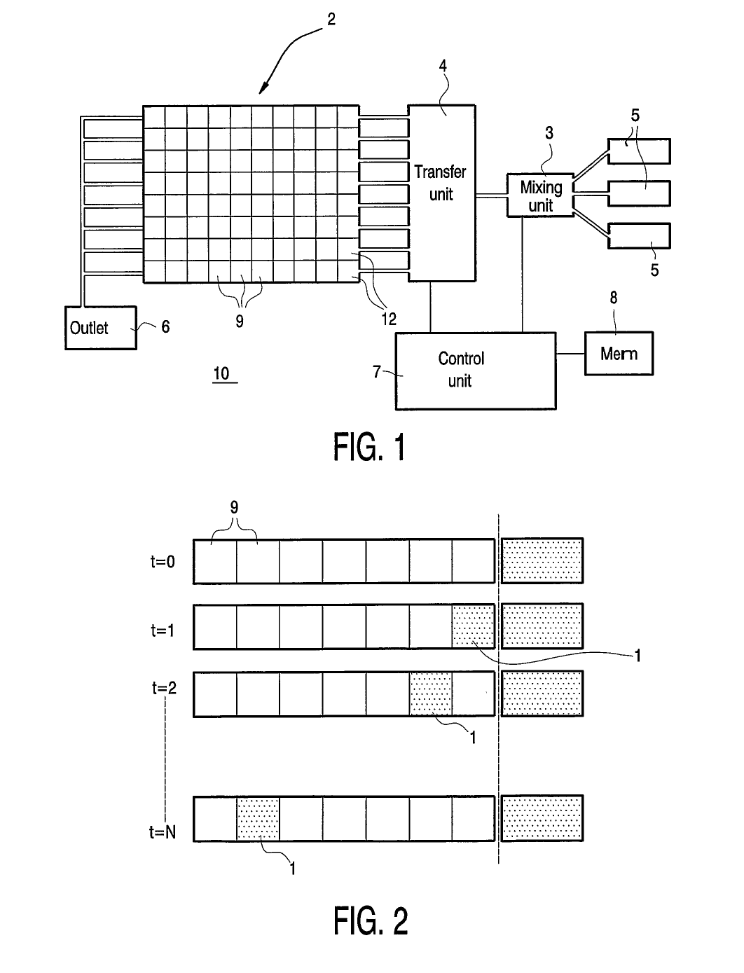

In FIG. 1, a schematic view is shown of a display apparatus 10 according to a first embodiment of the present invention. The display apparatus 10 comprises a display area 2 having N rows 12 by M columns of pixels 9. Each of the rows 12 of the display area 2 is connected to a transfer unit 4 by fluid lines. The transfer unit 4 input is connected by a fluid line to an output of a mixing unit 3, which in turn is connected to a number of pixel fill material containers 5 (three shown in this embodiment). The other side of the rows of the display area 2 are connected to an outlet 6, which allows to collect color material once removed from the display area 2. The mixing unit 3 and transfer unit 4 are connected to and controlled by a control unit 7, which in this embodiment is also connected to a memory 8 for storing one or more digital images.

The pixel fill material containers 5 comprise a quantity of e.g. color material of one color, such as an ink or dye, and may be provided as color ink cartridges. The three containers 5 may e.g. comprise primary colors (red, green, blue) or alternatively subtractive colors (cyan, magenta, yellow), or more containers 5 may be provided for other colors. A transparent color (or white in the case of a reflective display area 2) may also be added to control the transparency of each pixel 9. The possible colors may further even include metallic inks, such as gold or silver inks. By choosing the right set of pigments, inks or dyes, it would be possible to present every possible image on the display apparatus, even closely resembling a real painting. The mixing unit 3, under control of the control unit 7, mixes a predefined quantity 1 of pixel fill or color material to obtain a specific color for a single pixel 9 of the display area 2. This predefined quantity for a specific pixel, also called color filter unit 1, is transferred from the mixing unit 3 by means of the transfer unit 4 to the specific pixel 9 for which the color filter unit 1 is made. Each color filter unit 1 is tunable (any desired color can be obtained) and moveable (from the transfer unit 4 to the correct pixel 9, e.g. via the side of the display area 2).

In the embodiment shown in FIG. 1, the transfer unit 4 is connected to each of the rows of the display area 2, and is arranged to transfer the color filter unit 1 to the correct row 12. As shown in the time frame view of FIG. 2, a color filter unit 1 may be transported in a single row in discrete time steps, thus allowing to fill up a complete row 12 of pixels 9 with color filter units 1 corresponding to the pixels of an image. By filling row after row of the display area 2, a complete image can be composed.

Alternatively, the transfer unit 4 is arranged to compose a complete column of color filter units 1 and transfer these to the display area 2 one column at a time.

It will be clear that the transfer unit 4 might also be arranged to transport the color filter unit 1 to each pixel 9 directly, or to use a column wise arrangement, in which the display area 2 is filled column by column.

In a further embodiment, a mixing unit 3 and transfer unit 4 are provided for each of the rows of the display area 2, or for a sub group of rows of the display area 2. This allows to fill up the rows of pixels 9 of the complete display area 2 in parallel, which will require less time.

Each pixel of the present display apparatus can have a specified color, even beyond the normal RGB color space of present day CRT displays and LCD's. Thus, it is possible to use the present display apparatus as an electronic artwork, which closely resembles a real painting. The construction of the present display apparatus may be much less costly than possible alternatives for an electronic artwork, such as LCD's.

The present display apparatus is made up of pixels 9 which can have any color. It is thus possible to provide a (part of) the display area having a single color, as opposed to present day CRT displays or LCDs, in which sub pixels of the primary colors are used. This results in a display capability with an improved color intensity and clarity, resulting in a much richer color impression of the display apparatus 10.

As the present display apparatus uses color material, e.g. in the form of ink or dye, it is possible to use the display apparatus for reflective or transmissive displays. A backlighting is not a requisite, so no continuous power consumption will occur. For a reflective type of display apparatus, the color material (ink or dye) can be reflective itself, or if the color material is transparent, a white reflector or diffuser can be positioned behind the display area 2. Ambient light sources (sunlight, lamps, etc.) may then provide illumination. For a transmissive type of display apparatus, a backlight may be positioned behind the display area 2. As an alternative to a backlight, also existing light (sunlight, artificial light, etc.) may be used as an illumination source.

The control unit 7 retrieves information on each pixel of an image front the memory 8, and controls the mixing unit 3 and transfer unit 4 to provide the correct color material to each pixel 9 in the display area 2. The memory 8 may be in any form of memory suited to store image information, such as a magnetic or optical disc, semiconductor memory (RAM, Flash RAM, etc.). The memory 8 may store more than one image, and the control unit 7 may be arranged to periodically change the image from one image to a next image. This would make the display apparatus specifically suited for billboards and other forms of advertising displays. Even further, the control unit 7 may be arranged to change (part of) an image depending on external factors, such as weather, season, holiday event, predetermined dates such as birthday, etc.

Furthermore, it is possible to provide the control unit 7 (or the memory 8) with image information via other data input means, such as serial or parallel data input ports (not shown), e.g. to receive image data via the Internet. Also, it is possible to have a further input device, which would allow a person to (directly) compose an image on the display area 2, thus providing a true electronic canvas. The control unit 7 could be provided with e.g. a photodiode to automatically verify the image composition process, such as by verifying the transparency of the fluid.

In various further embodiments, the display apparatus 10 may be used as a changeable artwork, e.g. presenting a landscape image which changes according to season, weather, or even according to time of day. Changing to display of another image may be preprogrammed by a user, or may be random.

The present display apparatus 10 is able to change the image displayed, by substituting the color filter units 1 in each of the pixels 9 of the display area 2. When the display apparatus 10 has the arrangement of FIG. 1, each row 12 is connected to an outlet 6 which may collect the color filter units 1 once used. The display apparatus 10 will thus consume ink or dye, which may be possible by using replaceable ink cartridges as the color material containers 5. Alternatively, recycling a collected ink mixture is possible, which would be most easy if only RGB colors are used. In this case an extra separation apparatus or processing step is needed between the outlet 6 and the containers 5 in FIG. 1. This separation apparatus or processing step (re)separates the different color materials, prior to reinserting them in containers 5.

In an alternative arrangement of the display apparatus, a separate display area 2 is provided for each of the primary colors as provided by the color material containers 5, each having an associated outlet 6. This embodiment would still allow to provide a full display apparatus, but would also allow to re-use the color material after it has been collected in the outlets 6.

In a typical set up of the display apparatus 10, the layer thickness of the color material is 5-10 μm, which would require 5-10 ml of color material per square meter of display area 2 surface.

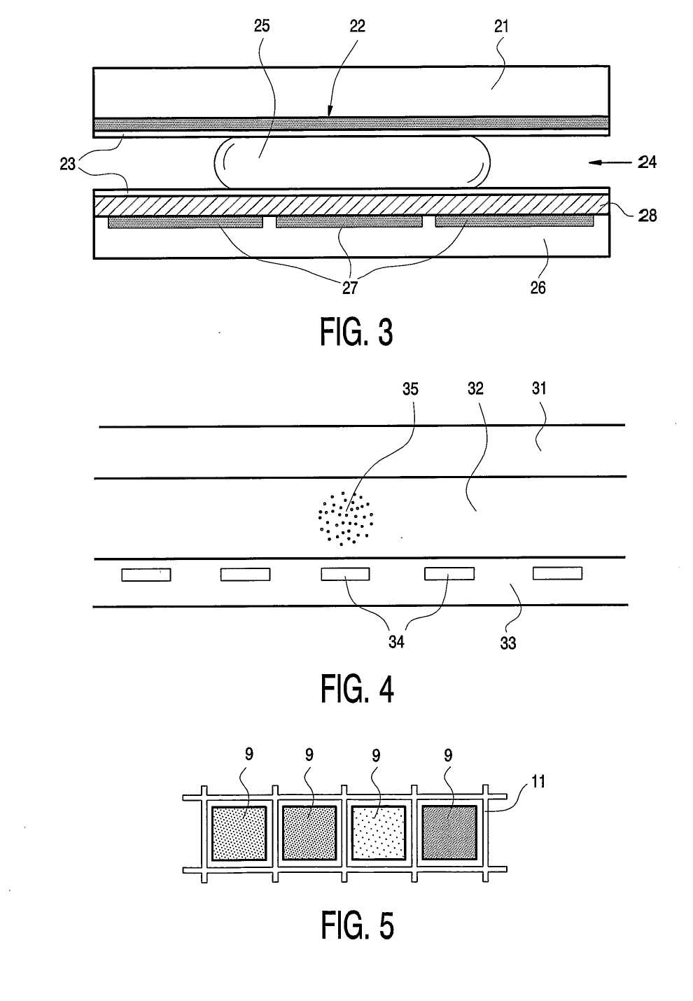

In FIG. 3, a first possible mechanism for an embodiment of the display apparatus of the present invention is illustrated. In this embodiment, an electro-wetting mechanism is used, in which the color filter units 1 comprise droplets of colored oil. The droplet may be oil (moving in water) but may also be water (moving in a gas like fluid). In the cross sectional view of FIG. 3, it is shown that the display area 2 comprises a top plate 21 and a bottom plate 26. The top plate 21 is provided with a ground electrode 22 across its entire surface. The bottom plate 26 is provided with a plurality of pixel electrodes 27 with a layer of insulating material 28 on top. Both the ground electrode 22 and the insulating layer 28 are provided with a hydrophobization layer 23. In between the hydrophobization layers 23 of top plate and bottom plate, a fluid layer 24 is present, in which droplets 25 of colored oil may be present. An electric field on a pixel position (which may be applied using the ground electrode 22 and one of the pixel electrodes 27) modifies the wetting behavior of the droplet 25. If an electric field is created in the fluid layer 24 in a non-uniform manner, a surface energy gradient is formed, which can be used to manipulate the droplet 25 across the fluid layer 24. This allows to manipulate a large number of individual droplets 25 (color filter units) in the display area 2 without using pumps, valves or the like, and without the necessity for fixed channels.

The electro-wetting mechanism may also be utilized for extracting the color material from the color material containers 5. By using different primary colors for the colored oil, any desired color can be achieved. The mixing of the oil may be performed in the mixing unit 4, but alternatively, the mixing unit 4 is only arranged for extracting the proper amount of each of the different colors for composing a color filter unit. The actual mixing of the different colors in the color filter unit 1 may then be achieved by the transfer of the color filter unit to the correct pixel 9.

The electro-wetting mechanism allows a color filter unit to be transported with a speed in the order of 10 cm/s. Assuming a display area 2 of one by one meter with a resolution of 1000×1000 pixels 9, and introduction of color filter units from the middle at the side of the display, a color filter unit needs to be transported 50 cm in vertical direction, which takes 5 seconds. By the time the top and bottom pixel of the column are filled, the other pixels in that column are also filled, as these color filter units follow in the trail of the top and bottom color filter units. This needs to be repeated for every column of the display area, which would result in a complete image to be built up in 5000 seconds. The image construction time may be decreased by e.g. introducing multiple mixing units 3 and transfer units 4.

In an alternative embodiment of the present display apparatus, the transfer mechanism is based on electrophoresis. In this embodiment, the color filter unit 1 (or predetermined quantity of color material) comprises small charged color filter particles suspended in a clear fluid. For electrophoresis the fluid preferably is clear but it may be colored. The display area 2 according to this embodiment is illustrated in the cross sectional view of FIG. 4. It comprises a top layer 31 and bottom layer 33, in which the bottom layer 33 is provided with pixel electrodes 34. Between the top and bottom layer 31, 33 is a fluid channel 32. In FIG. 4, the color particles of the color filter unit 1 are indicated by reference numeral 35.

As the small color particles 35 are charged, they can be moved by an electric field, e.g. generated using the pixel electrodes 34. For optimum performance, the electric field is directed in the plane of the display area 2, i.e. in the longitudinal direction of the fluid layer 32 in FIG. 4.

The estimated color filter unit 1 speed in the display area 2 depends on the color particle 35 mobility and the applied electric field. Typical mobilities are in the order of 170×10⁻¹² m²V⁻¹s⁻², and a typical electric field in the order of 1 V/μm, which would result in a particle speed of 170 μm/s. Therefore, this electrophoresis embodiment will take longer time to produce a complete image in the display area then the electro-wetting embodiment of FIG. 3. Also, it is important that the color particles 35 of a color filter unit 1 are kept together during the transfer to the correct pixel. This may be accomplished using a narrow distribution of particle mobility for each of the used color materials. Because of the slow speed of this embodiment one would provide one mixing unit 3 and transfer unit 4 per row. A possible application where this low refresh rate might not be a problem is if the image represents a part of a landscape that is slowly scrolling over the display.

The display apparatus embodiments described with respect to FIG. 3 and FIG. 4 are bi-stable, i.e. once a color filter unit 1 has been transported to its proper pixel position, and the total image has been constructed on the display area 2, no more power is required (except for possible backlighting if required). In the case of the electro-wetting implementation of FIG. 3, the hydrophobization layer 23 attracts the oil, such that the droplet 25 spreads equally over the pixel 9 surface once the transfer potential are removed. When the thickness of the oil film is in the order of 5-10 μm, gravitatonal forces will not effect the adhesion of the oil to the layer 23. In the case of the electrophoresis implementation of FIG. 4, the electric fields are only required for transport. Once the electric field is removed, the charged color particles 35 remain where they are, likely due to aggregation. In this embodiment, the particles 35 preferably have substantially the same density as the fluid in which they are suspended. Also other mechanisms may be used, e.g. the use of particles 35 which show a sticking behavior to other particles 35 or to the pixel surface, e.g. due to electrostatic phenomena.

In the display apparatus 10 according to the present invention, it is important that the color material (or color filter units 1) of neighboring pixels 9 do not mix, during transport or in a finished state of the display apparatus. To accomplish this effect, barriers 11 may be positioned between neighboring pixels 9, as shown in the schematic view of FIG. 5. When the transfer of color filter units 1 is implemented using row feeds, as in the embodiment shown in FIG. 1, it is possible to use horizontal physical barriers like walls.

In the electro-wetting embodiment of the present display apparatus 10, it is possible to use a grid of barriers 11 between the pixels 9 with a coating that repels the oil, and thus confines the oil to the pixel 9. Alternatively, the barriers 11 are in the form of a grid of conducting electrodes operating at very low power (order of a few volts). Also, only a set of parallel electrodes may be provided as barriers 11, arranged column wise or row wise, e.g. in combination with physical barriers in the other direction. As a result of the low power electric field, the electro-wetting contact angle may be influenced, and as a result, the color filter units 1 are confined to their respective pixel 9 positions. This would allow to build a display apparatus 10 having N×M pixels 9, and use N+2M electrodes to control the display area 2 of the display apparatus 10 (N row electrodes plus M column electrodes for addressing each pixel 9, plus M barrier electrodes 11 between the pixels 9).

A low voltage electrode grid 11 may also be used in the electrophoresis embodiment of FIG. 4. The potential differences between the individual pixel electrodes 34 and the grid 11 confine the particles 35 to the pixel 9. Although this type of confinement requires additional power at the finished state of the display apparatus, and thus not a truly bi-stable display results, the required power is much lower than during the transfer phase of the display apparatus 10.

The present display apparatus 10 intrinsically has a low refresh rate, so it is not very suited for video applications. However, the present display apparatus in any of the embodiments described above is most suited for applications where only a low refresh rate is needed (in the order of hours). Advertisement is a typical application area, as poster, billboard or shelf edge displays are only refreshed after hours, days or even weeks. Another application area would be artwork, as these type of images usually require a long display period, in which a slow change of image after the long display period is not a disadvantage.

Although in the above embodiments and in the figures, the display area 2 is illustrated as a flat display, the present display apparatus 10 is not limited to flat displays. By using e.g. plastic substrates, curved display apparatus may be created, such as an advertisement pillar. Also, reflective displays and transmissive displays may be made using a display apparatus according to the present invention, or a combination of reflective and transmissive properties may be used. In this case, reflective properties may be used advantageously in daylight conditions, while transmissive properties may be using a backlight arrangement when insufficient daylight is available. Also, a semi-transparent display apparatus may be envisaged, e.g. in the form of a shop window, using semi-transparent color material in the display apparatus 10, or in the form of a changeable stained-glass window, where transparent color filters are used to obtain the stained glass effect.

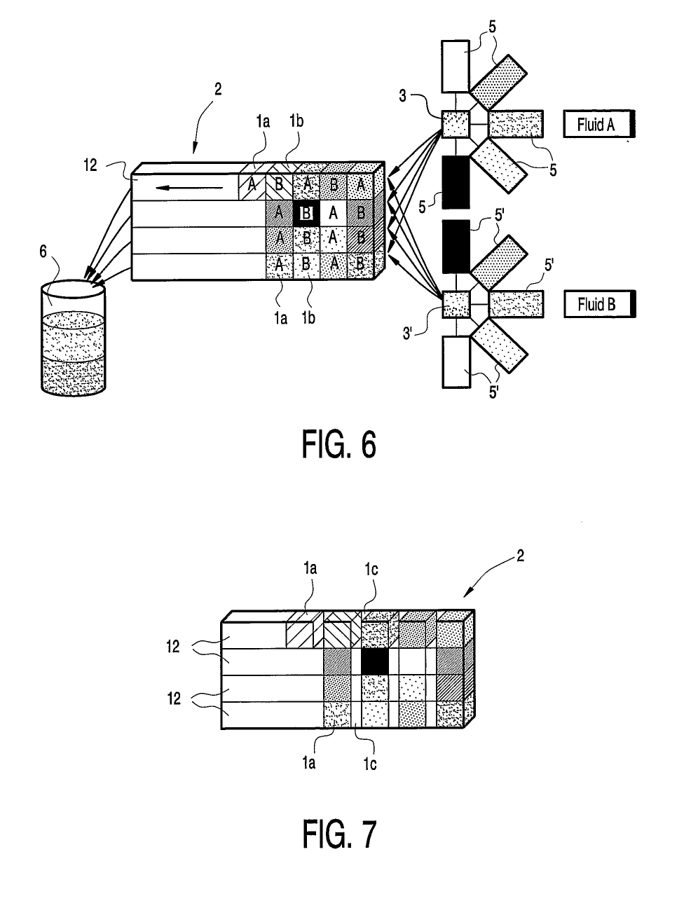

In a further series of embodiments, the present invention comprises a display 10 in which the rows or columns 12 of the display area 2 are made up of a number of thin channels or tubes, with at least one transparent side (see also FIG. 6 below). These channels are filled with droplets 1 of a definable color, that effectively form the pixels 9 of the display area 2. The colored droplets (or color filter units) 1 are prepared by mixing the required amount of differently colored (e.g. red/green/blue or cyan/magenta/yellow and black/white) fluids from reservoirs 5, 5′ into a mixing chamber 3, 3′, followed by injection into the channels 12 (e.g. using a transfer unit 4 as shown in FIG. 1). The main constituent of these droplets 1 is a clear fluid, together with some color-defining component (dye or pigment). At least two types of fluids A, B, that are immiscible among each other, are used. Note that for each different type of fluid, a separate reservoir/mixing setup (3, 5; 3′, 5′) is required.

A simplified view of the display area 2 of this embodiment is shown in FIG. 6. By filling the channels 12 alternately with droplets 1 containing first one fluid A, then another fluid B, whole ‘stacks’ of differently colored pixels 9 can be made. These stacks have excellent color separation since the materials in the adjoining pixels 9 cannot mix, leading to an inherently stable display effect. No active means for maintaining the color/pixel separation is required. Also, no back plate with electrodes is required to move the droplets 1, as each stack of droplets is moved along by injection of another droplet into the channel 12. When the channel 12 is full, the oldest droplets will be discarded into a waste container 6 for later disposal or re-use.

The color filter reservoirs 5, 5′ for this embodiment can have three or more primary colors, alternatively subtractive colors (CMY) can also be used. By adding also transparent ‘color’ (white or just clear fluid), the transparency (and hence grey scale) of the pixels 9 can be controlled. In a first step the correct quantity of color filter material (color filter unit 1) is selected from the different color reservoirs 5 containing fluid A. In a second step all the colors are mixed. In a third step the mixed droplet 1 is transported to the first (most right) pixel on the selected row 12. Note that in this embodiment, it is also possible to do the mixing directly in the first pixel itself, without the need of a separate mixing unit 3. The first, second and third step are repeated for all the pixels 9 on the most right column of the display area 2, each time filling the rightmost pixel of another row 12. When this most right column is full, the first row can be filled again by the first, second and third steps, this time using the reservoir/mixing setup 3′, 5′ containing fluid B. By repeating this process, alternately using fluids A and B, the complete display area 2 can be filled. In FIG. 6, the color filter units with fluid A are indicated with reference numeral 1a, and color filter units with fluid B with reference numeral 1b. Note that one does not have to wait before the entire column is filled with fluid A before starting the process with fluid B. The process with fluid B can already be started once the first pixel of a column has been filled with fluid A, so that effectively two columns are filled in one sweep (2-nozzle filling).

Injection into the channels 12, as well as injection from the reservoirs 5 into the mixing unit 3, is achieved by applying pressure on a droplet 1 (of desired quantity). This may be done for example by employing a piezoelectric element, or by applying heat (vaporization of a small amount of fluid). Both techniques are well-known from inkjet printing technology. In effect, the display is ‘printed’ from one of its sides. Other means of transferring fluids (e.g. pumps) can also be used. The display apparatus according to this einbodiment can be used in a reflective mode (by combining with a reflector) or in emissive mode by combining with a front- or backlight (in the latter case the system should be transparent).

Obviously, for the colored fluids, materials systems should be available that do not mix with each other. Possible combinations of solvents are aqueous/organic (apolar) systems (e.g. alkenes), aqueous/fluorinated (hydrocarbons) systems or organic/fluorinated systems. A system with three immiscible fluids could consist of aqueous/apolar organic/fluorinated organic. Instead of only liquids, also combinations with gases (e.g. air) can be used, e.g. aqueous/air. Even a 4-component system is feasible this way: aqueous/air/apolar organic/fluorinated organic. Other options and combinations are also possible. Note that when using gas, although it is conceivable that the gas may also be colored, it is much more likely that it is used as a colorless material.

The colored components for the different solvents can be dyes (forming colored solutions) or pigments (forming colored dispersions). In the latter case, the dispersion should be colloidally stable: no aggregation or sedimentation should occur. In all cases, the colored component should be highly compatible with the solvent/dispersant it is intended for, but not be compatible with the other fluids. In other words: no transfer of colored component should occur between the different fluids. This is very feasible. Furthermore, the colored component should not be significantly surface active, to prevent inadvertent mixing or emulsification of the different fluids with each other. Finally, the different colorants for a given fluid have to be compatible with each other, including any additives that may be required.

The channels 12 themselves should consist of or be coated with a material that minimizes the interaction (surface energy) between the tube and the fluids, to prevent unwanted spreading and allow for facile transport of the colored droplets 1 without any residue remaining.

In a further embodiment of the present display apparatus 10, of which the display area 2 is shown schematically in FIG. 7, the color of only one fluid can be controlled, and the second fluid (immiscible with the first) is used in a colorless, transparent state (although black or another fixed color is also an option), functioning as a separation 1c between the colored droplets 1a of the first fluid. The second fluid may be a liquid or a gas. Although some aperture is lost this way, as the second fluid does not contribute to the display effect, it has the advantage that only one mixing arrangement (such as containers 5, mixing unit 3 and transfer unit 4 of FIG. 1) is required. Also, in the waste stream, the second fluid can easily be re-used as it is not contaminated with colorants (in the case of a liquid) or may not even have to be actively recycled at all (in the case of a gas (air)). In FIG. 7, the width of the separations 1c is exaggerated for clarity: in an actual application, the amount of second fluid may be much less, e.g. a factor ten or even hundred less, than the predetermined amount of the first fluid (color filter unit 1a).

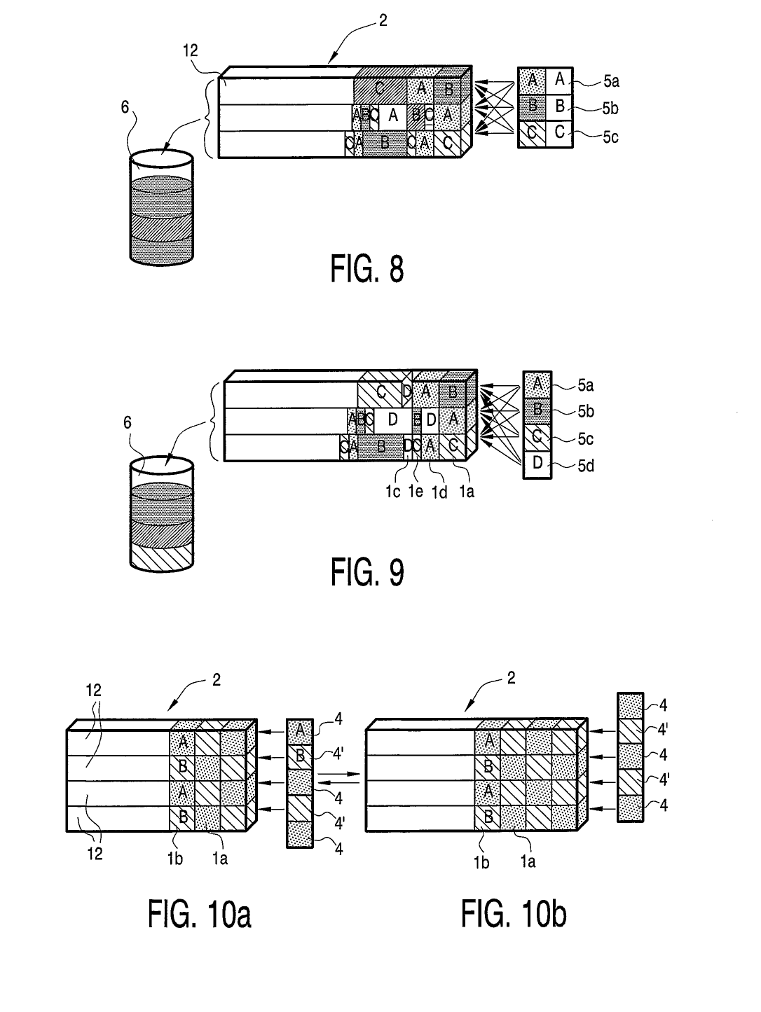

It is also possible to use three different immiscible fluids A, B, C (more may also be an option) as shown schematically in FIG. 8. Although there is no real advantage when color mixing is used, it is advantageous from a material recycling point of view. In the embodiments described above, eventually the colored droplets 1 end up in a waste container 6. Although it will be relatively easy to separate the two different fluid systems, within each fluid a mixture of all colored components is present that may be difficult to separate, so recycling can be a problem. Even though the material use is low (˜5-10 ml of fluid per square meter of display) and for material manufacturers it can be attractive to have consumables in a display, recycling (external or internal) is desirable. A very simple way to achieve this is by using three different immiscible fluids A, B, C, where each fluid has one color only. Grey scales may be produced by dilution of the colored fluid with the clear fluid (i.e. the fluid without the colored component). In effect this means sub-pixelation since mixed colors are produced by placing combinations of suitably colored droplets 1 next to one another. This approach leads to waste of light (especially in a reflective application). However, due to the nature of the display apparatus 10 (being sort of a dynamic color filter), this can easily be minimized. As opposed to a traditional display (e.g. an LCD with a static color filter), where only one third of the display area is available for a given ‘primary’ color (R, G or B), leading to 67% loss of light in the case only one color has to be displayed, here the entire area of a pixel 9 can be used per color by using variable droplet sizes (see FIG. 8). So, in case only red is required, the entire volume of a pixel 9 (or more pixels 9) can be filled with only one of the fluids (the red one). By using smart combinations of different droplet size, mixed colors with good brightness and saturation can be achieved. White or black (depending on the reflector used) may still be less than optimal, but this may be overcome by adding a fourth or even fifth type of fluid with the desired optical characteristics. The advantage is that each fluid layer in the waste container contains only one type of color component (albeit diluted). The layers can be separated with ease and the materials can be reused. In principle, the recycling may be done within the device itself.

An even further alternative to this embodiment can be provided as a display with four immiscible liquid elements A, B, C, D, as shown in FIG. 9 (e.g. three liquid, one gas), with a set color for each liquid and grey scale control by volume of gaseous (white) pixels. Now, a fourth fluid element is introduced in the form of a colorless gas D (e.g. air) that is immiscible with the other three fluid (liquid) elements A, B, C, that have set colors (e.g. RGB). Once again, colors are defined by injection of controlled volumes of the different fluids (sub-pixelation). As shown in FIG. 9, different sizes of sub-pixels can be provided, indicated with color filter units 1a, 1c, 1d and 1e. Grey scales are now not controlled by dilution, but by injection of the required amount of the colorless gas D (in combination with a white reflector), that is also used to prepare the white pixels. The advantage is that the colored liquid systems A, B, C, D in the waste stream 6 are now not diluted, and can be re-used immediately after separation of the liquid layers. So, internal recycling can be done with ease.

These embodiments using immiscible fluids as a base for the color filter units 1 are not inherently limited in speed such as in the case of electro-wetting or electro-phoretic migration of colored material, and thus, refresh rates of the display apparatus 10 may be much higher. Although by it's nature (edge-filling), it may not be suitable for video, high refresh rates can nonetheless be achieved. An embodiment of this display apparatus 10 is shown in FIG. 10. In this case, the use of more than two nozzles 4, 4′ as transfer unit 4 (one per fluid in the case of two different fluids, arranged in an alternating manner) is an option to speed up the filling rate. Then, the number of nozzles 4, 4′ should preferably be equal to the number of channels 12 plus one. Half of the nozzles should be for the first fluid A (indicated by 4), the other half for the second fluid B (indicated by 4′). Each of the nozzles 4, 4′ is supplied with fluids A, B from a corresponding fluid container (not shown in FIG. 10). The nozzles 4, 4′ are arranged in an alternate fashion with respect to the channels, as schematically shown in FIG. 10(a) and 10(b). In step one, all nozzles 4, 4′ minus one (the lowest in FIG. 10) will fill their respective channels 12. Then all nozzles 4, 4′ are shifted up one channel 12, and fill again their respective channels 12. Now the upper nozzle 4 is inactive. Then the nozzles are shifted down one row, and the cycle begins anew. Note that during each filling round one nozzle (4 or 4′) is inactive.

In principle, each nozzle could have its own color reservoir 5, but that would make for a very awkward arrangement. It is probably easier to have ‘central’ reservoirs (for each ‘primary’ color and solvent A, B) feeding all the nozzles 4, 4′. Other multi-nozzle setups are of course also possible in the case of 3- or 4-fluid systems.

As stated before, due to the nature of the display, video applications are less likely. However, the setup of the latter embodiment is very well suited for ‘scrolling’ applications, whereby for example a landscape moves across the display (e.g. for ‘inside window’ applications).

Although the present invention has been described above with embodiments relating to a display apparatus using a color material, the display apparatus according to the present invention may also be utilized as a filter or a mask, on which a predetermined pattern or image is present. The color material can then be used, but also another pixel fill material may be used, such as an active material, e.g. an active material which interacts with electromagnetic radiation. In this manner, e.g., large area UV or X-ray filters/masks may be provided.

1. Display apparatus comprising a display area having a plurality of pixels,
a mixing unit for preparing a predetermined quantity of pixel fill material for one of the plurality of pixels, and
a transfer unit for transferring the predetermined quantity for a pixel to the associated pixel position in the display area.

2. Display apparatus according to claim 1, further comprising a control unit connected to the mixing unit and the transfer unit for composing a predetermined image in the display area.

3. Display apparatus according to claim 2, further comprising a memory unit connected to the control unit for storing one or more images.

4. Display apparatus according to claim 2, in which the control unit is arranged to change the predetermined image for display on the display area depending on external inputs.

5. Display apparatus according to claim 1, in which the display area comprises a plurality of rows with pixels.

6. Display apparatus according to claim 5, in which a mixing unit and transfer unit is provided for each of the plurality of rows.

7. Display apparatus according to claim 1, in which the transfer unit and the display area are arranged for electro-wetting based transport of the pixel fill material.

8. Display apparatus according to claim 7, in which the display area comprises a top electrode and a plurality of pixel electrodes opposite the top electrode.

9. Display apparatus according to claim 1, in which the transfer unit and the display area are arranged for transport of the pixel fill material based on electrophoresis.

10. Display apparatus according to claim 9, in which the display area comprises a plurality of pixel electrodes for providing an electrical field from one pixel to a neighboring pixel.

11. Display apparatus according to claim 1, in which the display area comprises barriers between neighboring pixels.

12. Display apparatus according to claim 11, in which the barriers comprise electrical barriers.

13. Display apparatus according to claim 1, in which the display area comprises at least one channel, and
the color fill material for neighboring pixels comprises different immiscible fluids.

14. Display apparatus according to claim 1, in which the display area comprises at least one channel, and in which first predetermined quantities of color fill material for neighboring pixels are separated by a second predetermined amount of a fluid which is immiscible with the predetermined quantity of color fill material.

15. Display apparatus according to claim 14, in which the second predetermined amount is smaller than the first predetermined amount.

16. Display apparatus according to claim 13, in which the size of pixels in the display area is varied by varying the predetermined amount of color fill material.

17. Display apparatus according to claims 13, in which the different immiscible fluids are chosen from the group comprising an aqueous fluid, a gaseous fluid, an apolar organic fluid, an fluorinated organic fluid.

18. Display apparatus according to claim 1, further comprising an outlet connected to the plurality of pixels for receiving the predetermined quantity of pixel fill material when refreshing a pixel.

19. Display apparatus according to claim 1, in which the mixing unit receives the pixel fill material from one or more pixel fill material containers.

20. Display apparatus according to claim 1, in which a plurality of display areas are provided and each of the plurality of display areas can receive pixel fill material of a single type.

21. Electronic painting comprising a display apparatus according to claim 1.

22. Advertising display comprising a display apparatus according to claim 1.
